(19) United States
(12) Patent Application Publication
(10) Pub. No.: US 2024/0185881 A1
(43) Pub. Date: Jun. 6, 2024

(54) SYSTEM AND METHOD FOR SMART BROADCAST MANAGEMENT

(71) Applicant: Cochlear Limited, Macquarie University, New South Wales (AU)

(72) Inventors: Jamon Windeyer, Sydney (AU); Henry Hu Chen, Northwood (AU); Jan Patrick Frieding, Grose Vale (AU); Stephen Fung, Macquarie University (AU)

(21) Appl. No.: 18/556,177

(22) PCT Filed: May 4, 2022
(86) PCT No.: PCT/IB2022/054124

§ 371 Date: Oct. 19, 2023

Related U.S. Application Data
(60) Provisional application No. 63/190,112, filed on May 18, 2021.

(51) Int. Cl. G10L 25/78; G10L 15/08; H04R 25/00

(52) U.S. Cl. CPC G10L 25/78; G10L 15/08; H04R 25/554; G10L 2015/088; H04R 2225/43; H04R 2225/55

(57) ABSTRACT

An apparatus includes voice activity detection (VAD) circuitry configured to analyze one or more audio broadcast streams and to identify first segments of the one or more broadcast streams in which the audio data includes speech data. The apparatus further includes derivation circuitry configured to receive the first segments and, for each first segment, to derive one or more words from the speech data of the first segment. The apparatus further includes keyword detection circuitry configured to, for each first segment, receive the one or more words and to generate keyword information indicative of whether at least one word of the one or more words is among a set of stored keywords. The apparatus further includes decision circuitry configured to receive the first segments, the one or more words of each of the first segments, and the keyword information for each of the first segments and, for each first segment, to select, based at least in part on the keyword information, among a plurality of options regarding communication of information indicative of the first segment to a recipient.

### BACKGROUND

### Field

The present application relates generally to systems and methods for receiving broadcasted information by a device worn or held by a user and managing (e.g., filtering; annotating; storing) the information prior to being presented to the user.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises voice activity detection (VAD) circuitry configured to analyze one or more broadcast streams comprising audio data, to identify first segments of the one or more broadcast streams in which the audio data includes speech data, and to identify second segments of the one or more broadcast streams in which the audio data does not include speech data. The apparatus further comprises derivation circuitry configured to receive the first segments and, for each first segment, to derive one or more words from the speech data of the first segment. The apparatus further comprises keyword detection circuitry configured to, for each first segment, receive the one or more words and to generate keyword information indicative of whether at least one word of the one or more words is among a set of stored keywords. The apparatus further comprises decision circuitry configured to receive the first segments, the one or more words of each of the first segments, and the keyword information for each of the first segments and, for each first segment, to select, based at least in part on the keyword information, among a plurality of options regarding communication of information indicative of the first segment to a recipient.

In another aspect disclosed herein, a method comprises receiving one or more electromagnetic wireless broadcast streams comprising audio data. The method further comprises dividing the one or more electromagnetic wireless broadcast streams into a plurality of segments comprising speech-including segments and speech-excluding segments. The method further comprises evaluating the audio data of each speech-including segment for inclusion of at least one keyword. The method further comprises based on said evaluating, communicating information regarding the speech-including segment to a user.

In another aspect disclosed herein, a non-transitory computer readable storage medium has stored thereon a computer program that instructs a computer system to segment real-time audio information into distinct sections of information by at least: receiving one or more electromagnetic wireless broadcast streams comprising audio information; segmenting the one or more electromagnetic wireless broadcast streams into a plurality of sections comprising speech-including sections and speech-excluding sections; evaluating the audio information of each speech-including section for inclusion of at least one keyword; and based on said evaluating, communicating information regarding the speech-including section to a user.

### BRIEF DESCRIPTION OF THE DRAWINGS

Implementations are described herein in conjunction with the accompanying drawings, in which:

FIG. 1 is a perspective view of an example cochlear implant auditory prosthesis implanted in a recipient in accordance with certain implementations described herein;

FIG. 2 is a perspective view of an example fully implantable middle ear implant auditory prosthesis implanted in a recipient in accordance with certain implementations described herein;

FIG. 3A schematically illustrates an example system comprising a device worn by a recipient or implanted on and/or within the recipient's body in accordance with certain implementations described herein;

FIG. 3B schematically illustrates an example system comprising an external device worn, held, and/or carried by a recipient in accordance with certain implementations described herein;

FIG. 3C schematically illustrates an example system comprising a device worn by a recipient or implanted on and/or within the recipient's body and an external device worn, held, and/or carried by the recipient in accordance with certain implementations described herein;

FIG. 4A schematically illustrates an example apparatus in accordance with certain implementations described herein;

FIG. 4B schematically illustrates the example apparatus, in accordance with certain implementations described herein, as a component of the device, the external device, or divided among the device and the external device; and

FIGS. 5A-5C are flow diagrams of example methods in accordance with certain implementations described herein.

### DETAILED DESCRIPTION

Certain implementations described herein provide a device (e.g., hearing device) configured to receive wireless broadcasts (e.g., Bluetooth 5.2 broadcasts; location-based Bluetooth broadcasts) that stream many audio announcements, at least some of which are of interest to the user of the device. The received wireless broadcasts can include a large number of audio announcements that are not of interest to the user which can cause various problems (e.g., interfering with the user listening to ambient sounds, conversations, or other audio streams; user missing the small number of announcements of interest within the many audio announcements, thereby creating uncertainty, confusion, and/or stress and potentially impacting the user's safety). For example, a user at a transportation hub (e.g., an airport; train station; bus station) is likely only interested in the small fraction of relevant announcements pertaining to the user's trip (e.g., flight number and gate number at an airport).

Certain implementations described herein utilize a keyword detection based mechanism to analyze the broadcast stream, to segment the broadcast stream into distinct sections of information (e.g., announcements), and to intelligently manage the broadcast streams in the background without the user actively listening to the streams and to notify the user of relevant announcements in an appropriate fashion. For example, relevant announcements can be stored and replayed to ensure that none are missed by the user (e.g., by the user listening to them at a more convenient time); preceded by a warning tone (e.g., beep) and played back in response to a user-initiated signal. For another example, relevant announcements can be converted to text or other visually displayed information relayed to the user (e.g., via a smart phone or smart watch display). The keyword detection based mechanism can be tailored directly by the user (e.g., to present only certain categories of announcements selected by the user; on a general basis for all broadcasts; on a per-broadcast basis) and/or can receive information from other integrated services (e.g., calendars; personalized profiling module providing user-specific parameters for keyword detection/notification), thereby ensuring that relevant information is conveyed to the user while streamlining the user's listening experience.

The teachings detailed herein are applicable, in at least some implementations, to any type of implantable or non-implantable stimulation system or device (e.g., implantable or non-implantable auditory prosthesis device or system). Implementations can include any type of medical device that can utilize the teachings detailed herein and/or variations thereof. Furthermore, while certain implementations are described herein in the context of auditory prosthesis devices, certain other implementations are compatible in the context of other types of devices or systems (e.g., smart phones; smart speakers).

Merely for ease of description, apparatus and methods disclosed herein are primarily described with reference to an illustrative medical device, namely an implantable transducer assembly including but not limited to: electro-acoustic electrical/acoustic systems, cochlear implant devices, implantable hearing aid devices, middle ear implant devices, bone conduction devices (e.g., active bone conduction devices; passive bone conduction devices, percutaneous bone conduction devices; transcutaneous bone conduction devices), Direct Acoustic Cochlear Implant (DACI), middle ear transducer (MET), electro-acoustic implant devices, other types of auditory prosthesis devices, and/or combinations or variations thereof, or any other suitable hearing prosthesis system with or without one or more external components. Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

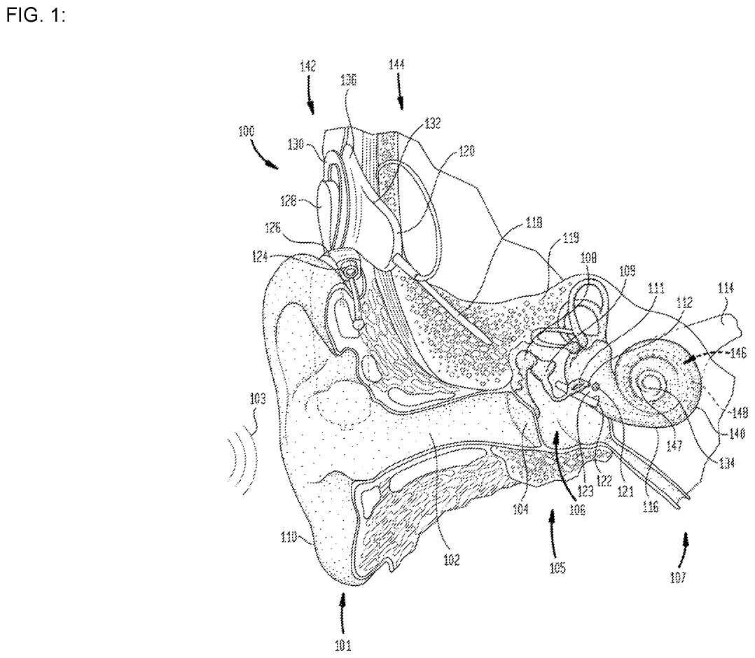

FIG. 1 is a perspective view of an example cochlear implant auditory prosthesis 100 implanted in a recipient in accordance with certain implementations described herein. The example auditory prosthesis 100 is shown in FIG. 1 as comprising an implanted stimulator unit 120 and a microphone assembly 124 that is external to the recipient (e.g., a partially implantable cochlear implant). An example auditory prosthesis 100 (e.g., a totally implantable cochlear implant; a mostly implantable cochlear implant) in accordance with certain implementations described herein can replace the external microphone assembly 124 shown in FIG. 1 with a subcutaneously implantable microphone assembly, as described more fully herein. In certain implementations, the example cochlear implant auditory prosthesis 100 of FIG. 1 can be in conjunction with a reservoir of liquid medicament as described herein.

As shown in FIG. 1, the recipient has an outer ear 101, a middle ear 105, and an inner ear 107. In a fully functional ear, the outer ear 101 comprises an auricle 110 and an ear canal 102. An acoustic pressure or sound wave 103 is collected by the auricle 110 and is channeled into and through the ear canal 102. Disposed across the distal end of the ear canal 102 is a tympanic membrane 104 which vibrates in response to the sound wave 103. This vibration is coupled to oval window or fenestra ovalis 112 through three bones of middle ear 105, collectively referred to as the ossicles 106 and comprising the malleus 108, the incus 109, and the stapes 111. The bones 108, 109, and 111 of the middle ear 105 serve to filter and amplify the sound wave 103, causing the oval window 112 to articulate, or vibrate in response to vibration of the tympanic membrane 104. This vibration sets up waves of fluid motion of the perilymph within cochlea 140. Such fluid motion, in turn, activates tiny hair cells (not shown) inside the cochlea 140. Activation of the hair cells causes appropriate nerve impulses to be generated and transferred through the spiral ganglion cells (not shown) and auditory nerve 114 to the brain (also not shown) where they are perceived as sound.

As shown in FIG. 1, the example auditory prosthesis 100 comprises one or more components which are temporarily or permanently implanted in the recipient. The example auditory prosthesis 100 is shown in FIG. 1 with an external component 142 which is directly or indirectly attached to the recipient's body, and an internal component 144 which is temporarily or permanently implanted in the recipient (e.g., positioned in a recess of the temporal bone adjacent auricle 110 of the recipient). The external component 142 typically comprises one or more sound input elements (e.g., an external microphone 124) for detecting sound, a sound processing unit 126 (e.g., disposed in a Behind-The-Ear unit), a power source (not shown), and an external transmitter unit 128. In the illustrative implementations of FIG. 1, the external transmitter unit 128 comprises an external coil 130 (e.g., a wire antenna coil comprising multiple turns of electrically insulated single-strand or multi-strand platinum or gold wire) and, preferably, a magnet (not shown) secured directly or indirectly to the external coil 130. The external coil 130 of the external transmitter unit 128 is part of an inductive radio frequency (RF) communication link with the internal component 144. The sound processing unit 126 processes the output of the microphone 124 that is positioned externally to the recipient's body, in the depicted implementation, by the recipient's auricle 110. The sound processing unit 126 processes the output of the microphone 124 and generates encoded signals, sometimes referred to herein as encoded data signals, which are provided to the external transmitter unit 128 (e.g., via a cable). As will be appreciated, the sound processing unit 126 can utilize digital processing techniques to provide frequency shaping, amplification, compression, and other signal conditioning, including conditioning based on recipient-specific fitting parameters.

The power source of the external component 142 is configured to provide power to the auditory prosthesis 100, where the auditory prosthesis 100 includes a battery (e.g., located in the internal component 144, or disposed in a separate implanted location) that is recharged by the power provided from the external component 142 (e.g., via a transcutaneous energy transfer link). The transcutaneous energy transfer link is used to transfer power and/or data to the internal component 144 of the auditory prosthesis 100. Various types of energy transfer, such as infrared (IR), electromagnetic, capacitive, and inductive transfer, may be used to transfer the power and/or data from the external component 142 to the internal component 144. During operation of the auditory prosthesis 100, the power stored by the rechargeable battery is distributed to the various other implanted components as needed.

The internal component 144 comprises an internal receiver unit 132, a stimulator unit 120, and an elongate electrode assembly 118. In some implementations, the internal receiver unit 132 and the stimulator unit 120 are hermetically sealed within a biocompatible housing. The internal receiver unit 132 comprises an internal coil 136 (e.g., a wire antenna coil comprising multiple turns of electrically insulated single-strand or multi-strand platinum or gold wire), and preferably, a magnet (also not shown) fixed relative to the internal coil 136. The internal receiver unit 132 and the stimulator unit 120 are hermetically sealed within a biocompatible housing, sometimes collectively referred to as a stimulator/receiver unit. The internal coil 136 receives power and/or data signals from the external coil 130 via a transcutaneous energy transfer link (e.g., an inductive RF link). The stimulator unit 120 generates electrical stimulation signals based on the data signals, and the stimulation signals are delivered to the recipient via the elongate electrode assembly 118.

The elongate electrode assembly 118 has a proximal end connected to the stimulator unit 120, and a distal end implanted in the cochlea 140. The electrode assembly 118 extends from the stimulator unit 120 to the cochlea 140 through the mastoid bone 119. In some implementations, the electrode assembly 118 may be implanted at least in the basal region 116, and sometimes further. For example, the electrode assembly 118 may extend towards apical end of cochlea 140, referred to as cochlea apex 134. In certain circumstances, the electrode assembly 118 may be inserted into the cochlea 140 via a cochleostomy 122. In other circumstances, a cochleostomy may be formed through the round window 121, the oval window 112, the promontory 123, or through an apical turn 147 of the cochlea 140.

The elongate electrode assembly 118 comprises a longitudinally aligned and distally extending array 146 of electrodes or contacts 148, sometimes referred to as electrode or contact array 146 herein, disposed along a length thereof. Although the electrode array 146 can be disposed on the electrode assembly 118, in most practical applications, the electrode array 146 is integrated into the electrode assembly 118 (e.g., the electrode array 146 is disposed in the electrode assembly 118). As noted, the stimulator unit 120 generates stimulation signals which are applied by the electrodes 148 to the cochlea 140, thereby stimulating the auditory nerve 114.

While FIG. 1 schematically illustrates an auditory prosthesis 100 utilizing an external component 142 comprising an external microphone 124, an external sound processing unit 126, and an external power source, in certain other implementations, one or more of the microphone 124, sound processing unit 126, and power source are implantable on or within the recipient (e.g., within the internal component 144). For example, the auditory prosthesis 100 can have each of the microphone 124, sound processing unit 126, and power source implantable on or within the recipient (e.g., encapsulated within a biocompatible assembly located subcutaneously), and can be referred to as a totally implantable cochlear implant (“TICI”). For another example, the auditory prosthesis 100 can have most components of the cochlear implant (e.g., excluding the microphone, which can be an in-the-ear-canal microphone) implantable on or within the recipient, and can be referred to as a mostly implantable cochlear implant (“MICI”).

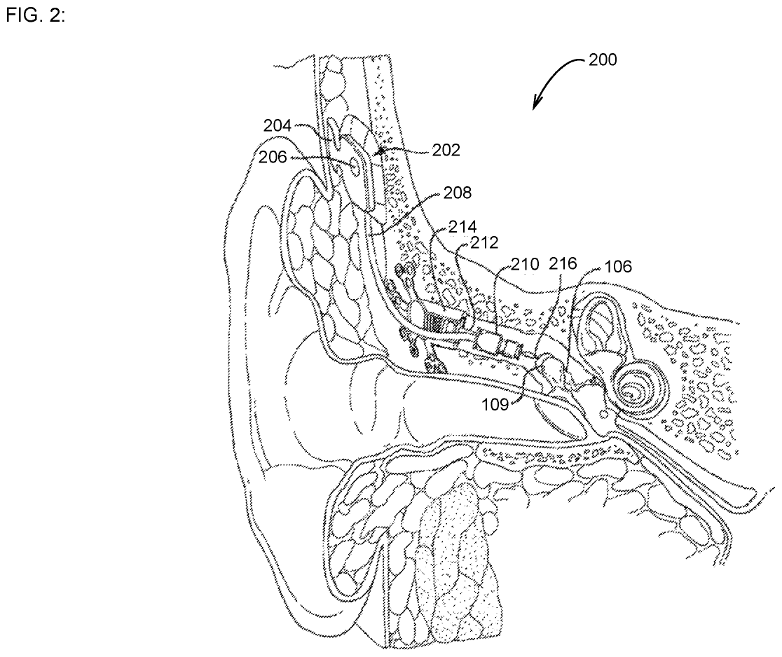

FIG. 2 schematically illustrates a perspective view of an example fully implantable auditory prosthesis 200 (e.g., fully implantable middle ear implant or totally implantable acoustic system), implanted in a recipient, utilizing an acoustic actuator in accordance with certain implementations described herein. The example auditory prosthesis 200 of FIG. 2 comprises a biocompatible implantable assembly 202 (e.g., comprising an implantable capsule) located subcutaneously (e.g., beneath the recipient's skin and on a recipient's skull). While FIG. 2 schematically illustrates an example implantable assembly 202 comprising a microphone, in other example auditory prostheses 200, a pendant microphone can be used (e.g., connected to the implantable assembly 202 by a cable). The implantable assembly 202 includes a signal receiver 204 (e.g., comprising a coil element) and an acoustic transducer 206 (e.g., a microphone comprising a diaphragm and an electret or piezoelectric transducer) that is positioned to receive acoustic signals through the recipient's overlying tissue. The implantable assembly 202 may further be utilized to house a number of components of the fully implantable auditory prosthesis 200. For example, the implantable assembly 202 can include an energy storage device and a signal processor (e.g., a sound processing unit). Various additional processing logic and/or circuitry components can also be included in the implantable assembly 202 as a matter of design choice.

For the example auditory prosthesis 200 shown in FIG. 2, the signal processor of the implantable assembly 202 is in operative communication (e.g., electrically interconnected via a wire 208) with an actuator 210 (e.g., comprising a transducer configured to generate mechanical vibrations in response to electrical signals from the signal processor). In certain implementations, the example auditory prosthesis 100, 200 shown in FIGS. 1 and 2 can comprise an implantable microphone assembly, such as the microphone assembly 206 shown in FIG. 2. For such an example auditory prosthesis 100, the signal processor of the implantable assembly 202 can be in operative communication (e.g., electrically interconnected via a wire) with the microphone assembly 206 and the stimulator unit of the main implantable component 120. In certain implementations, at least one of the microphone assembly 206 and the signal processor (e.g., a sound processing unit) is implanted on or within the recipient.

The actuator 210 of the example auditory prosthesis 200 shown in FIG. 2 is supportably connected to a positioning system 212, which in turn, is connected to a bone anchor 214 mounted within the recipient's mastoid process (e.g., via a hole drilled through the skull). The actuator 210 includes a connection apparatus 216 for connecting the actuator 210 to the ossicles 106 of the recipient. In a connected state, the connection apparatus 216 provides a communication path for acoustic stimulation of the ossicles 106 (e.g., through transmission of vibrations from the actuator 210 to the incus 109).

During normal operation, ambient acoustic signals (e.g., ambient sound) impinge on the recipient's tissue and are received transcutaneously at the microphone assembly 206. Upon receipt of the transcutaneous signals, a signal processor within the implantable assembly 202 processes the signals to provide a processed audio drive signal via wire 208 to the actuator 210. As will be appreciated, the signal processor may utilize digital processing techniques to provide frequency shaping, amplification, compression, and other signal conditioning, including conditioning based on recipient-specific fitting parameters. The audio drive signal causes the actuator 210 to transmit vibrations at acoustic frequencies to the connection apparatus 216 to affect the desired sound sensation via mechanical stimulation of the incus 109 of the recipient.

The subcutaneously implantable microphone assembly 202 is configured to respond to auditory signals (e.g., sound; pressure variations in an audible frequency range) by generating output signals (e.g., electrical signals; optical signals; electromagnetic signals) indicative of the auditory signals received by the microphone assembly 202, and these output signals are used by the auditory prosthesis 100, 200 to generate stimulation signals which are provided to the recipient's auditory system. To compensate for the decreased acoustic signal strength reaching the microphone assembly 202 by virtue of being implanted, the diaphragm of an implantable microphone assembly 202 can be configured to provide higher sensitivity than are external non-implantable microphone assemblies. For example, the diaphragm of an implantable microphone assembly 202 can be configured to be more robust and/or larger than diaphragms for external non-implantable microphone assemblies.

The example auditory prostheses 100 shown in FIG. 1 utilizes an external microphone 124 and the auditory prosthesis 200 shown in FIG. 2 utilizes an implantable microphone assembly 206 comprising a subcutaneously implantable acoustic transducer. In certain implementations described herein, the auditory prosthesis 100 utilizes one or more implanted microphone assemblies on or within the recipient. In certain implementations described herein, the auditory prosthesis 200 utilizes one or more microphone assemblies that are positioned external to the recipient and/or that are implanted on or within the recipient, and utilizes one or more acoustic transducers (e.g., actuator 210) that are implanted on or within the recipient. In certain implementations, an external microphone assembly can be used to supplement an implantable microphone assembly of the auditory prosthesis 100, 200. Thus, the teachings detailed herein and/or variations thereof can be utilized with any type of external or implantable microphone arrangement, and the acoustic transducers shown in FIGS. 1 and 2 are merely illustrative.

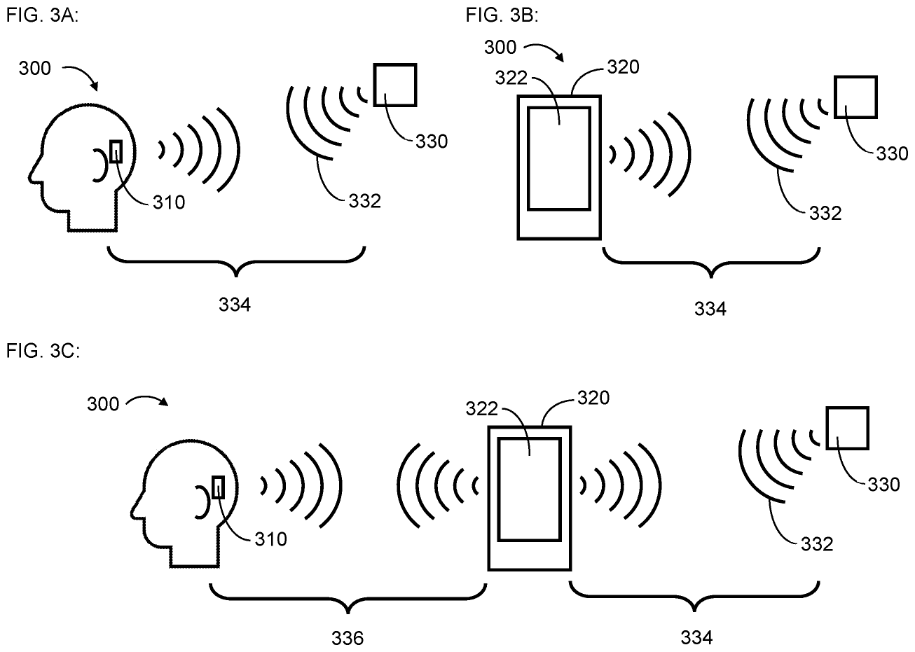

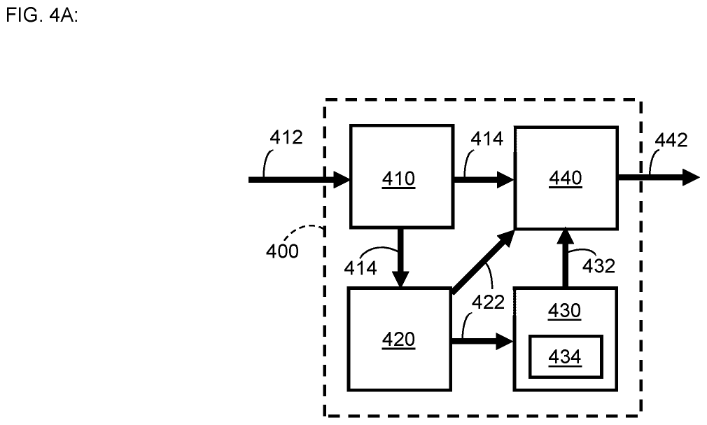

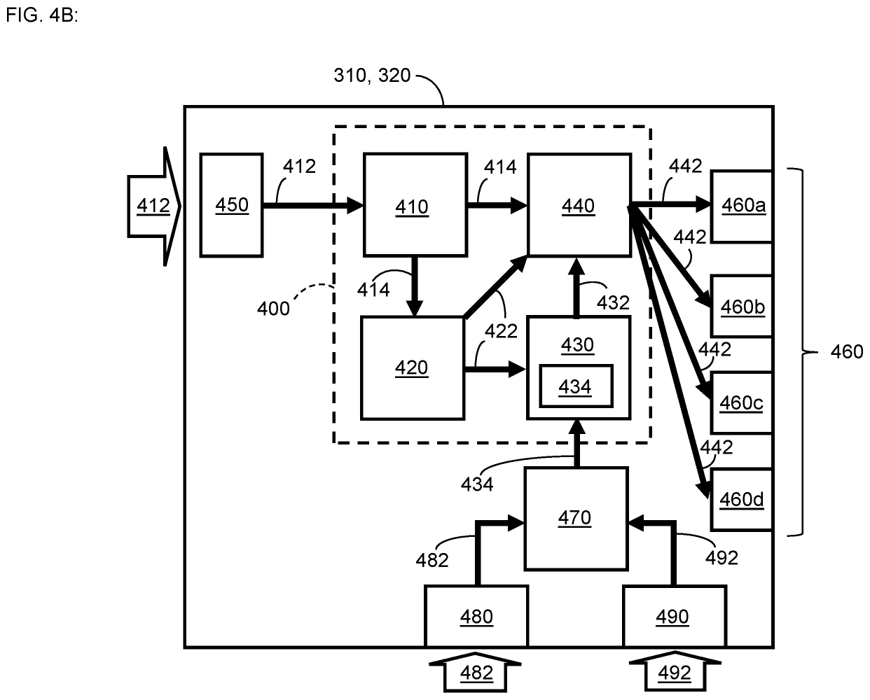

FIG. 3A schematically illustrates an example system 300 comprising a device 310 worn by a recipient or implanted on and/or within the recipient's body in accordance with certain implementations described herein. FIG. 3B schematically illustrates an example system 300 comprising an external device 320 worn, held, and/or carried by a recipient in accordance with certain implementations described herein. FIG. 3C schematically illustrates an example system 300 comprising a device 310 worn by a recipient or implanted on and/or within the recipient's body and an external device 320 worn, held, and/or carried by the recipient in accordance with certain implementations described herein. The example systems 300 of FIGS. 3A-3C are each in wireless communication with at least one remote broadcast system 330 configured to transmit wireless electromagnetic signals 332 corresponding to one or more broadcast streams comprising audio data. For example, the audio data can include announcements relevant to one or more users within the range (e.g., spatial extent) of the at least one remote broadcast system 330 (e.g., announcements at an airport, train station, boat dock, or other transportation facility; announcements at a conference, sporting event, or other public or private event).

As schematically illustrated by FIG. 3A, the device 310 is configured to receive the electromagnetic signals 332 directly from the at least one remote broadcast system 330 via a wireless communication link 334 (e.g., WiFi; Bluetooth; cellphone connection, telephony, or other Internet connection). For example, the device 310 can be configured to receive the one or more broadcast streams (e.g., audio broadcast streams) directly from at least one remote broadcast system 330 and to provide information from the audio data (e.g., via stimulation signals; via sound) to the recipient. As schematically illustrated by FIG. 3B, the external device 320 is configured to receive the electromagnetic signals 332 directly from the at least one broadcast system 330 via a wireless communication link 334 (e.g., WiFi; Bluetooth; cellphone connection, telephony, or other Internet connection) and to provide information (e.g., via stimulation signals; via sound) from the audio data to the recipient. For example, the external device 320 can be configured to receive the one or more broadcast streams from at least one remote broadcast system 330 and to transmit information (e.g., via sound; via text) from the audio data to the recipient. As schematically illustrated by FIG. 3C, the external device 320 is configured to receive the electromagnetic signals 332 directly from the at least one broadcast system 330 via a first wireless communication link 334 (e.g., WiFi; Bluetooth; cellphone connection, telephony, or other Internet connection) and is configured to transmit at least a portion of the one or more broadcast streams to the device 310 via a second wireless communication link 336 (e.g., WiFi; Bluetooth; radio-frequency (RF); magnetic induction). For example, the external device 320 can be configured to receive the one or more broadcast streams from at least one remote broadcast system 330 and to transmit information (e.g., via the second wireless communication link 336) from the audio data to the device 310 which is configured to provide the information (e.g., via stimulation signals; via sound) to the recipient. In certain implementations, the device 310 of FIGS. 3A and 3C comprises multiple devices 310 implanted or worn on the recipient's body. For example, the device 310 can comprise two hearing prostheses, one for each of the recipient's ears (e.g., a bilateral cochlear implant pair; a sound processor and a hearing aid). The multiple devices 310 can be operated in sync with one another (e.g., a pair of cochlear implant devices which both receive information from the audio data from the external device 320 or directly from the at least one broadcast system 330). In certain implementations, the multiple devices 310 operate independently from one another, while in certain other implementations, the multiple devices 310 operate as a “parent” device which controls operation of a “child” device.

In certain implementations, the device 310 and/or the external device 320 are in operative communication with one or more geographically remote computing devices (e.g., remote servers and/or processors; “the cloud”) which are configured to perform one or more functionalities as described herein. For example, the device 310 and/or the external device 320 can be configured to transmit signals to the one or more geographically remote computing devices via the at least one broadcast system 330 (e.g., via one or both of the wireless communication links 334, 336) as schematically illustrated by FIGS. 3A-3C. For another example, the device 310 and/or the external device 320 can be configured to transmit signals to the one or more geographically remote computing devices via other wireless communication links (e.g., WiFi; Bluetooth; cellphone connection, telephony, or other Internet connection) that are not coupled to the at least one broadcast system 330.

In certain implementations, the device 310 comprises a transducer assembly, examples of which include but are not limited to: an implantable and/or wearable sensory prosthesis (e.g., cochlear implant auditory prosthesis 100; fully implantable auditory prosthesis 200; implantable hearing aid; wearable hearing aid, an example of which is a hearing aid that is partially or wholly within the ear canal); at least one wearable speaker (e.g., in-the-ear; over-the-ear; ear bud; headphone). In certain implementations, the device 310 is configured to receive auditory information from the ambient environment (e.g., sound detected by one or more microphones of the device 310) and/or to receive audio input from at least one remote system (e.g., mobile phone, television, computer), and to receive user input from the recipient (e.g., for controlling the device 310).

In certain implementations, the external device 320 comprises at least one portable device worn, held, and/or carried by the recipient. For example, the external device 320 can comprise an externally-worn sound processor (e.g., sound processing unit 126) that is configured to be in wired communication or in wireless communication (e.g., via RF communication link; via magnetic induction link) with the device 310 and is dedicated to operation in conjunction with the device 310. For another example, the external device 320 can comprise a device remote to the device 310 (e.g., smart phone, smart tablet, smart watch, laptop computer, other mobile computing device configured to be transported away from a stationary location during normal use). In certain implementations, the external device 320 can comprise multiple devices (e.g., a handheld computing device in communication with an externally-worn sound processor that is in communication with the device 310).

In certain implementations, the external device 320 comprises an input device (e.g., keyboard; touchscreen; buttons; switches; voice recognition system) configured to receive user input from the recipient and an output device (e.g., display; speaker) configured to provide information to the recipient. For example, as schematically illustrated by FIGS. 3B and 3C, the external device 320 can comprise a touchscreen 322 configured to be operated as both the input device and the output device. In certain implementations, the external device 320 is configured to transmit control signals to the device 310 and/or to receive data signals from the device 310 indicative of operation or performance of the device 310. The external device 320 can further be configured to receive user input from the recipient (e.g., for controlling the device 310) and/or to provide the recipient with information regarding the operation or performance of the device 310 (e.g., via a graphical user interface displayed on the touchscreen 322). In certain implementations, as schematically illustrated by FIG. 3C, the external device 320 is configured to transmit information (e.g., audio information) to the device 310 and the device 310 is configured to provide the information (e.g., via stimulation signals; via sound) to the recipient.

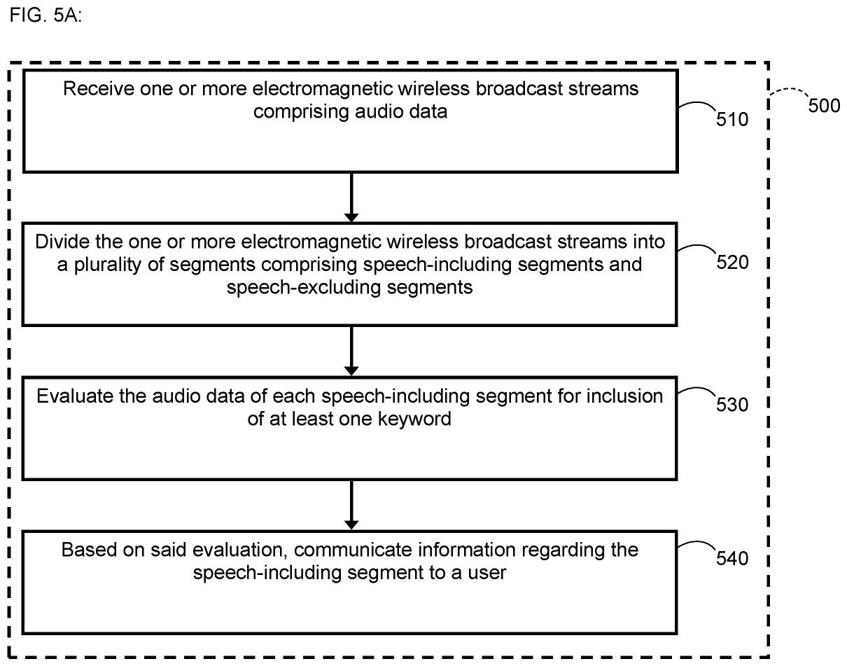

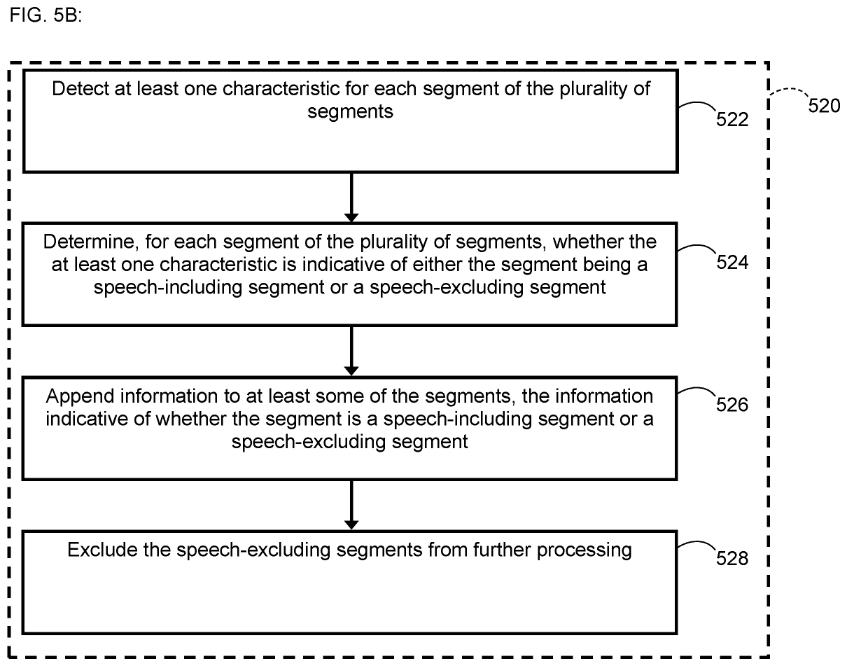

FIG. 4A schematically illustrates an example apparatus 400 in accordance with certain implementations described herein. The apparatus 400 comprises voice activity detection (VAD) circuitry 410 configured to analyze one or more broadcast streams 412 comprising audio data, to identify first segments 414 of the one or more broadcast streams 412 in which the audio data includes speech data, and to identify second segments of the one or more broadcast streams 412 in which the audio data does not include speech data. The apparatus 400 further comprises derivation circuitry 420 configured to receive the first segments 414 and, for each first segment 414, to derive one or more words 422 from the speech data of the first segment 414. The apparatus 400 further comprises keyword detection circuitry 430 configured to, for each first segment 414, receive the one or more words 422 and to generate keyword information indicative of whether at least one word of the one or more words 422 is among a set of stored keywords 434. The apparatus 400 further comprises decision circuitry 440 configured to receive the first segments 414, the one or more words 422 of each of the first segments 414, and the keyword information 432 for each of the first segments 414 and, for each first segment 414, to select, based at least in part on the keyword information 432, among a plurality of options regarding communication of information 442 indicative of the first segment 414 to a recipient.

FIG. 4B schematically illustrates the example apparatus 400, in accordance with certain implementations described herein, as a component of the device 310, the external device 320, or divided among the device 310 and the external device 320. In certain other implementations, at least a portion of the apparatus 400 resides in one or more one or more geographically remote computing devices that are remote from both the device 310 and the external device 320. In certain implementations, the apparatus 400 comprises one or more microprocessor (e.g., application-specific integrated circuits; generalized integrated circuits programmed by software with computer executable instructions; microelectronic circuitry; microcontrollers) of which the VAD circuitry 410, the derivation circuitry 420, the keyword detection circuitry 430, and/or the decision circuitry 440 are components. In certain implementations the one or more microprocessors comprise control circuitry configured to control the VAD circuitry 410, the derivation circuitry 420, the keyword detection circuitry 430, and/or the decision circuitry 440, as well as other components of the apparatus 400. For example, the external device 320 can comprise at least one microprocessor of the one or more microprocessors. For another example, the device 310 (e.g., a sensory prosthesis configured to be worn by a recipient or implanted on and/or within a recipient's body) can comprise at least one microprocessor of the one or more microprocessors.

In certain implementations, the one or more microprocessors comprise and/or are in operative communication with at least one storage device configured to store information (e.g., data; commands) accessed by the one or more microprocessors during operation (e.g., while providing the functionality of certain implementations described herein). The at least one storage device can comprise at least one tangible (e.g., non-transitory) computer readable storage medium, examples of which include but are not limited to: read only memory (ROM); random access memory (RAM); magnetic disk storage media; optical storage media; flash memory. The at least one storage device can be encoded with software (e.g., a computer program downloaded as an application) comprising computer executable instructions for instructing the one or more microprocessors (e.g., executable data access logic, evaluation logic, and/or information outputting logic). In certain implementations, the one or more microprocessors execute the instructions of the software to provide functionality as described herein.

As shown in FIG. 4B, the apparatus 400 can be in operative communication with at least one data input interface 450 (e.g., a component of the device 310 and/or the external device 320) configured to receive the one or more broadcast streams 412. Examples of the at least one data input interface 450 include but are not limited to ports and/or antennas configured for receiving at least one of: WiFi signals; Bluetooth signals; cellphone connection signals, telephony signals, or other Internet signals. In certain implementations, the at least one data input interface 450 is configured to detect the electromagnetic signals 332 from the at least one remote broadcast system 330 and to receive the broadcast stream 412 comprising the electromagnetic signals 332 in response to user input (e.g., the user responding to a prompt indicating that the broadcast remote broadcast system 330 has been detected) and/or automatically (e.g., based on learned behavior, such as detection of electromagnetic signals 332 from a remote broadcast system 330 that was connected to during a previous visit within the range of the remote broadcast system 330).

In certain implementations, the apparatus 400 can be configured to operate in at least two modes: a first (e.g., “normal”) operation mode in which the functionalities described herein are disabled and a second (e.g., “smart”) operation mode in which the functionalities described herein are enabled. For example, the apparatus 400 can switch between the first and second modes in response to user input (e.g., the user responding to a prompt indicating that the broadcast remote broadcast system 330 has been detected) and/or automatically (e.g., based on connection to and/or disconnection from a remote broadcast system 330). In certain implementations in which the one or more broadcast streams 412 are encoded (e.g., encrypted), the at least one data input interface 450 and/or other portions of the apparatus 400 are configured to decode (e.g., decrypt) the broadcast stream 412.

As shown in FIG. 4B, the apparatus 400 can be in operative communication with at least one data output interface 460 (e.g., a component of the device 310 and/or the external device 320) configured to be operatively coupled to a communication component (e.g., another component of the device 310 and/or the external device 320; a component separate from the device 310 and the external device 320) configured to communicate the information 442 indicative of the first segment 414 to the recipient. The at least one data output interface 460 can comprise any combination of wired and/or wireless ports, including but not limited to: Universal Serial Bus (USB) ports; Institute of Electrical and Electronics Engineers (IEEE) 1394 ports; PS/2 ports; network ports; Ethernet ports; Bluetooth ports; wireless network interfaces.

In certain implementations, the first segments 414 (e.g., segments including speech data) of the one or more broadcast streams 412 contain messages (e.g., sentences) with specific information of possible interest to the recipient (e.g., announcements regarding updates to scheduling or gates at an airport or train station; announcements regarding event schedules or locations at a conference, cultural event, or sporting event). The first segments 414 of a broadcast stream 412 can be separated from one another by one or more second segments (e.g., segments not including speech data) of the broadcast stream 412 that contain either no audio data or only non-speech audio data (e.g., music; background noise).

In certain implementations, the VAD circuitry 410 is configured to identify the first segments 414 and to identify the second segments by analyzing one or more characteristics of the audio data of the one or more broadcast streams 412. For example, based on the one or more characteristics (e.g., modulation depth; signal-to-noise ratio; zero crossing rate; cross correlations; sub-band/full-band energy measures; spectral structure in frequency range corresponding to speech (e.g., 80 Hz to 400 Hz); long term time-domain behavior characteristics), the VAD circuitry 410 can identify time intervals of the audio data of the one or more broadcast streams 412 that contain speech activity and time intervals of the audio data of the one or more broadcast streams 412 that do not contain speech activity. Examples of voice activity detection processes that can be performed by the VAD circuitry 410 in accordance with certain implementations described herein are described by S. Graf et al., “Features for voice activity detection: a comparative analysis,” EURASIP J. Adv. in Signal Processing, 2015:91 (2015); International Telecommunications Union, “ITU-T Telecommunications Standardization Sector of ITU: Series G: Transmission Systems and Media,” G.729 Annex B (1996); “Digital cellular telecommunications system (Phase 2+); Voice Activity Detector (VAD) for Adaptive Multi-Rate (AMR) speech traffic channels, General description, GSM 06.94 version 7.1.0 Release 1998,” ETSI EN 301 708 V7.1.0 (1999-07). In certain implementations, the VAD circuitry 410 is local (e.g., a component of the device 410 and/or the external device 420), while in certain other implementations, the VAD circuitry 410 is part of a remote server (e.g., “in the cloud”). In certain implementations in which the broadcast stream only contains first segments 414 (e.g., speech-including segments) separated by time intervals in which the broadcast stream 412 is not being broadcast (e.g., airport broadcast stream comprising only audio announcements separated by “silent” time intervals in which no audio data is transmitted), the VAD circuitry 410 can identify the first segments 414 as being the segments broadcasted between time intervals without broadcasted segments.

In certain implementations, the VAD circuitry 410 is configured to append information to at least some of the segments, the appended information indicative of whether the segment is a first segment 414 (e.g., speech-including segment) or a second segment (e.g., speech-excluding segment). For example, the appended information can be in the form of a value (e.g., zero or one) appended to (e.g., overlaid on) the segment based on whether the one or more characteristics (e.g., modulation depth; signal-to-noise ratio; zero crossing rate; cross correlations; sub-band/full-band energy measures; spectral structure in frequency range corresponding to speech (e.g., 80 Hz to 400 Hz); long term time-domain behavior characteristics) of the audio data of the segment is indicative of either the segment being a first segment 414 or a second segment. In certain implementations, the VAD circuitry 410 is configured to parse (e.g., divide) the first segments 414 from the second segments. For example, the VAD circuitry 410 can transmit the first segments 414 to circuitry for further processing (e.g., to memory circuitry for storage and further processing by other circuitry) and can discard the second segments. For another example, the VAD circuitry 410 can exclude the second segments from further processing (e.g., by transmitting the first segments 414 to the derivation circuitry 420 and to the decision circuitry 440 while not transmitting the second segments to either the derivation circuitry 420 or the decision circuitry 440).

In certain implementations, the derivation circuitry 420 is configured to analyze the speech data from the first segments 414 (e.g., received from the VAD circuitry 410) for the one or more words 422 contained within the speech data. For example, the derivation circuitry 420 can be configured to perform speech-to-text conversion (e.g., using a speech-to-text engine or application programming interface, examples of which are available from Google and Amazon) and/or other speech recognition processes (e.g., translation from one language into another). The derivation circuitry 420 can be configured to extract the one or more words 422 from the speech data in a form (e.g., text) compatible with further processing and/or with communication to the recipient as described herein. In certain implementations, as schematically illustrated by FIGS. 4A and 4B, the derivation circuitry 420 is configured to transmit the one or more words 422 to the keyword detection circuitry 430 and the decision circuitry 440. In certain other implementations, the derivation circuitry 420 is configured to transmit the one or more words 422 to the keyword detection circuitry 430 and the keyword detection circuitry 430 is configured to transmit the one or more words 422 to the decision circuitry 440. In certain implementations, the derivation circuitry 420 is part of the VAD circuitry 410 or vice versa. In certain implementations, the derivation circuitry 420 is local (e.g., a component of the device 410 and/or the external device 420), while in certain other implementations, the derivation circuitry 420 is part of a remote server (e.g., “in the cloud”).

In certain implementations, the keyword detection circuitry 430 is configured to receive the one or more words 422 (e.g., from the derivation circuitry 420), to retrieve the set of stored keywords 434 from memory circuitry and to compare the one or more words 422 to keywords of the set of stored keywords 434 (e.g., to determine the relevance of the first segment 414 to the user or recipient). For example, the set of stored keywords 434 (e.g., a keyword list) can be stored in memory circuitry configured to be accessed by the keyword detection circuitry 430 (e.g., memory circuitry of the keyword detection circuitry 430, as schematically illustrated by FIGS. 4A and 4B, or in other memory circuitry of the apparatus 400). In certain implementations, the apparatus 400 can access a plurality of sets of stored keywords 434 (e.g., different sets of stored keywords 434 for different broadcast streams 412, different broadcast systems 330, and/or different times of day) and one or more of the sets of stored keywords 434 can change (e.g., edited automatically or by the recipient) over time. The set of stored keywords 434 to be accessed for the comparison with the one or more words 422 can be selected based, at least in part, on the identity of the currently-received broadcast stream 412 and/or the identity of the broadcast system 330 broadcasting the currently-received broadcast stream 412. For example, upon receiving a broadcast stream 412 from an airport broadcast system 330, the keyword detection circuitry 430 can access a set of stored keywords 434 that is compatible for comparison with keywords expected to be within the broadcast stream 412 (e.g., gate changes; schedule changes).

In certain implementations, as schematically illustrated by FIG. 4B, the keyword detection circuitry 430 is in operative communication with keyword generation circuitry 470 configured to generate at least some keywords of the set of stored keywords 434 to be accessed by the keyword detection circuitry 430. In certain other implementations, the keyword generation circuitry 470 is a component of the keyword detection circuitry 430 or is another component of the apparatus 400.

As schematically illustrated by FIG. 4B, the keyword generation circuitry 470 of certain implementations is in operative communication with at least one input interface 480 configured to receive input information 482, and the keyword generation circuitry 470 is configured to generate the set of stored keywords 434 at least partially based on the input information 482. For example, the input information 482 can comprise information provided by the recipient (e.g., user input; manually entered via a keyboard or touchscreen; verbally entered via a microphone) indicative of keywords of interest to the recipient, information from a clock, calendar, or other software application of the device 310 and/or external device 320 (e.g., a clock/calendar app providing information regarding scheduled events and/or time of day; ticketing app providing information regarding information regarding stored tickets; geolocating app providing information regarding the recipient's location, such as work or transportation station) from which the keyword generation circuitry 470 can extract keywords, and/or other information from which the keyword generation circuitry 470 can extract (e.g., pluck; scrape) keywords or keyword-relevant information. In certain implementations, the keyword generation circuitry 470 is configured to generate the set of stored keywords 434 automatically (e.g., based on learned behavior, such as using a set of stored keywords 434 that was previously used when the apparatus 400 was previously receiving a broadcast stream 412 from the same broadcast system 330 that is providing the currently-received broadcast stream 412) and/or based on predetermined rules (e.g., words such as “evacuate” and “emergency” automatically being included in the set of stored keywords 434).

In certain implementations, the set of stored keywords 434 comprises, for each stored keyword 434, information indicative of an importance of the stored keyword 434. As schematically illustrated by FIG. 4B, the keyword generation circuitry 470 of certain implementations is in operative communication with at least one input interface 490 configured to receive input information 492, and the keyword generation circuitry 470 is configured to generate the set of stored keywords 434 at least partially based on the input information 492. The at least one input interface 490 and the at least one input interface 480 can be the same as one another or can be separate from one another. In certain implementations, the importance of a keyword is indicative of its relative importance as compared to other keywords. For example, keywords such as “evacuate” or “emergency” can have a higher importance than do other keywords. In certain implementations, the input information 492 can comprise information provided by the recipient (e.g., user input; manually entered via a keyboard or touchscreen; verbally entered via a microphone) indicative of the importance of one or more keywords of interest to the recipient, information from a clock, calendar, or other software application of the device 310 and/or external device 320 (e.g., a clock/calendar app providing information regarding scheduled events and/or time of day; ticketing app providing information regarding stored tickets; geolocating app providing information regarding the recipient's location) from which the keyword generation circuitry 470 can extract the importance of one or more keywords, and/or other information from which the keyword generation circuitry 470 can extract (e.g., pluck; scrape) the importance of one or more keywords. In certain implementations, the keyword generation circuitry 470 is configured to assign an importance to one or more keywords of the set of stored keywords 434 automatically (e.g., based on learned or past behavior, such as an importance of a keyword 434 that was previously used when the apparatus 400 was previously receiving a broadcast stream 412 from the same broadcast system 330 that is providing the currently-received broadcast stream 412) and/or based on predetermined rules (e.g., keywords such as “evacuate” and “emergency” automatically having the highest level of importance).

In certain implementations, for each first segment 414, the decision circuitry 440 is configured to, in response at least in part to the keyword information 432 (e.g., received from the keyword detection circuitry 430) corresponding to the first segment 414, select whether any information 442 indicative of the first segment 414 is to be communicated to the recipient. In certain implementations, the decision circuitry 440 is configured to compare the keyword information 432 for a first segment 414 to a predetermined set of rules to determine whether the first segment 414 is of sufficient interest (e.g., importance) to the recipient to warrant communication to the recipient. If the keyword information 432 indicates that the first segment 414 is not of sufficient interest, the decision circuitry 440 does not generate any information 442 regarding the first segment 414. If the keyword information 432 indicates that the first segment 414 is of sufficient interest, the decision circuitry 440 generates the information 442 regarding the first segment 414.

The decision circuitry 440, in response at least in part to the keyword information 432 corresponding to the first segment 414, can select among the data output interfaces 460 and can select the form and/or content of the information 442 indicative of the first segment 414 to be communicated to the recipient. In certain implementations, the first segments 414 and/or the one or more words 422 comprise at least part of the content of the information 422 to be communicated to the recipient via the data output interfaces 460. For example, the decision circuitry 440 can transmit the information 442 in the form of at least one text message indicative of the one or more words 422 of the first segment 414 to a data output interface 460a configured to receive the information 442 and to communicate the information 442 a screen configured to display the at least one text message to the recipient. For another example, the decision circuitry 440 can transmit the information 442 in the form of at least one signal indicative of a notification (e.g., alert; alarm) regarding the information 442 (e.g., indicative of whether the one or more words 422 of the first segment 414 comprises a stored keyword 434, indicative of an identification of the stored keyword 434, and/or indicative of an importance of the stored keyword 434) to a data output interface 460b configured to receive the at least one signal and to communicate the notification to the recipient as at least one visual signal (e.g., outputted by an indicator light or display screen), at least one audio signal (e.g., outputted as a tone or other sound from a speaker), and/or at least one tactile or haptic signal (e.g., outputted as a vibration from a motor). For another example, the decision circuitry 440 can transmit the information 442 in the form of at least one signal indicative of the audio data of the first segment 414 to a data output interface 460c configured to receive the at least one signal and to communicate the audio data to the recipient (e.g., outputted as sound from a speaker, such as a hearing aid or headphone; outputted as stimulation signals from a hearing prosthesis). For another example, the decision circuitry 440 can transmit the information 442 in the form of at least one signal compatible for storage to a data output interface 460d configured to receive the at least one signal and to communicate the information 442 to memory circuitry (e.g., at least one storage device, such as flash memory) to be stored and subsequently retrieved and communicated to the recipient (e.g., via one or more of the other data output interfaces 460a-c). For example, the decision circuitry 440 can be further configured to track the intent of the first segment 414 over time and can correspondingly manage the queue of information 442 in the memory circuitry (e.g., deleting older information 442 upon receiving newer information 442 about the same topic; learning the intent and/or interests of the user over time and stopping notifications to the user for certain types of information 442 not of interest). One or more of the data output interfaces 460 can be configured to receive the information 442 in multiple forms and/or can be configured to be in operative communication with multiple communication components. Other types of data output interfaces 460 (e.g., interfaces to other communication components) are also compatible with certain implementations described herein.

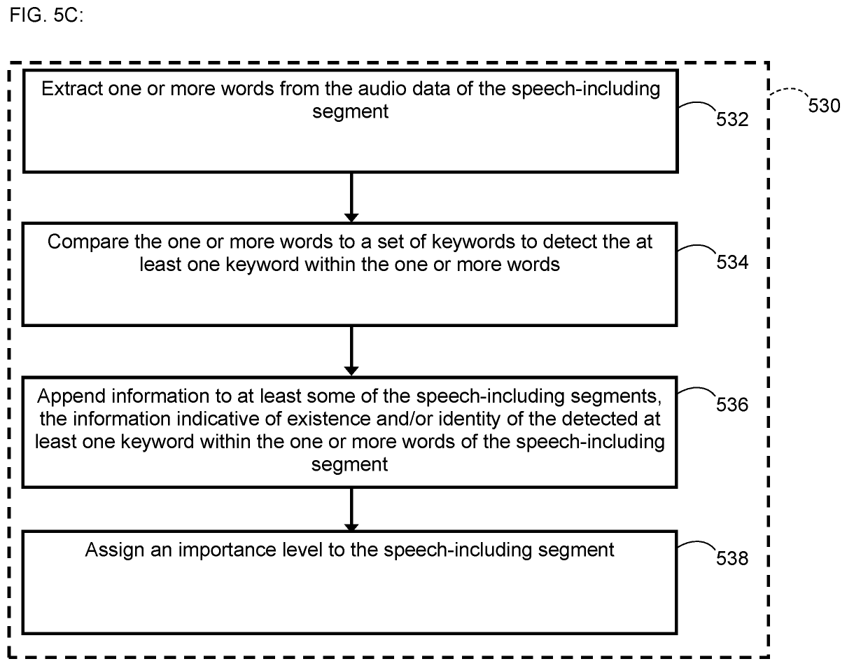

FIG. 5A is a flow diagram of an example method 500 in accordance with certain implementations described herein. While the method 500 is described by referring to some of the structures of the example apparatus 400 of FIGS. 4A-4B, other apparatus and systems with other configurations of components can also be used to perform the method 500 in accordance with certain implementations described herein. In certain implementations, a non-transitory computer readable storage medium has stored thereon a computer program that instructs a computer system to perform the method 500.

In an operational block 510, the method 500 comprises receiving one or more electromagnetic wireless broadcast streams 412 (e.g., at least one Bluetooth broadcast stream from at least one remote broadcast system 330) comprising audio data. For example, the one or more electromagnetic wireless broadcast streams 412 can be received by a personal electronic device (e.g., external device 320) worn, held, and/or carried by the user or implanted on or within the user's body (e.g., device 310).

In an operational block 520, the method 500 further comprises dividing the one or more broadcast streams 412 into a plurality of segments comprising speech-including segments (e.g., first segments 414) and speech-excluding segments. FIG. 5B is a flow diagram of an example of the operational block 520 in accordance with certain implementations described herein. In an operational block 522, dividing the one or more broadcast streams 412 can comprise detecting at least one characteristic (e.g., modulation depth; signal-to-noise ratio; zero crossing rate; cross correlations; sub-band/full-band energy measures; spectral structure in frequency range corresponding to speech (e.g., 80 Hz to 400 Hz); long term time-domain behavior characteristics) for each segment of the plurality of segments. In an operational block 524, dividing the one or more broadcast streams 412 can further comprise determining, for each segment of the plurality of segments, whether the at least one characteristic is indicative of either the segment being a speech-including segment or a speech-excluding segment. In an operational block 526, dividing the one or more broadcast streams 412 can further comprise appending information to at least some of the segments, the information indicative of whether the segment is a speech-including segment or a speech-excluding segment. In certain implementations, dividing the one or more broadcast streams 412 can further comprise excluding the speech-excluding segments from further processing in an operational block 528.

In an operational block 530, the method 500 further comprises evaluating the audio data of each speech-including segment for inclusion of at least one keyword 434. FIG. 5C is a flow diagram of an example of the operational block 530 in accordance with certain implementations described herein. In an operational block 532, evaluating the audio data can comprise extracting one or more words 422 from the audio data of the speech-including segment. In an operational block 534, evaluating the audio data can further comprise comparing the one or more words 422 to a set of keywords 434 to detect the at least one keyword 434 within the one or more words 422. The set of keywords 434 can be compiled from at least one of: user input, time of day, user's geographic location when the speech-including segment is received, history of previous user input, and/or information from computer memory or one or more computing applications. In an operational block 536, evaluating the audio data can further comprise appending information to at least some of the speech-including segments, the information indicative of existence and/or identity of the detected at least one keyword 434 within the one or more words 422 of the speech-including segment. In certain implementations, evaluating the audio data can further comprise assigning an importance level to the speech-including segment in an operational block 538. The importance level can be based at least in part on existence and/or identity of the at least one keyword, user input, time of day, user's geographic location when the speech-including segment is received, history of previous user input, and/or information from computer memory or one or more computing applications.

In an operational block 540, the method 500 further comprises, based on said evaluating, communicating information regarding the speech-including segment to a user. For example, based on whether the one or more words 422 includes at least one keyword 434, the identity of the included at least one keyword 434, and/or the importance level of the speech-including segment, the information regarding the speech-including segment can be selected to be communicated to the user or to not be communicated to the user. If the information is selected to be communicated, said communicating information can be selected from the group consisting of: displaying at least one text message to the user, the at least one text message indicative of the one or more words of the speech-including segment; providing at least one visual, audio, and/or tactile signal to the user, the at least one visual, audio, and/or tactile signal indicative of whether the speech-including segment comprises a keyword, an identification of the keyword, and/or an importance of the keyword; providing at least one signal indicative of the audio data of the speech-including segment to the user; and storing at least one signal indicative of the audio data of the speech-including segment in memory circuitry, and subsequently retrieving the stored at least one signal from the memory circuitry and providing the stored at least one signal to the user.

### Example Implementations

In one example, a recipient with a hearing prosthesis (e.g., device 310) with an external sound processor (e.g., external device 320) and a mobile device (e.g., smart phone; smart watch; another external device 320) in communication with the sound processor in accordance with certain implementations described herein can enter an airport where a location-based Bluetooth wireless broadcast (e.g., broadcast stream 412) is being used to mirror the normal announcements made over the speaker system. The mobile device can connect to the wireless broadcast (e.g., received via the data input interface 450) and can be toggled into a mode of operation (e.g., “smart mode”) enabling the functionality of certain implementations described herein. The recipient can enter keywords corresponding to the flight information (e.g., airline, flight number, gate number) and/or other relevant information into a dialog box of key terms via an input interface 480. As the recipient checks in, the mobile device can receive announcements from the wireless broadcast, split them into segments, and check for one or more of the keywords. Just after the recipient gets through security, a gate change for the recipient's flight number can be announced, and the mobile device can store this announcement in audio form and can notify the recipient via a tone (e.g., triple ascending beep) via the hearing prosthesis. The recipient can select to hear the announcement when the recipient chooses (e.g., once the recipient is done ordering a coffee; by pressing a button on the mobile device), and the mobile device can stream the stored audio of the announcement to the sound processor of the recipient's hearing prosthesis. The recipient can also select to replay the announcement when the recipient chooses (e.g., by pressing the button again within five seconds of completion of the streaming of the stored audio the previous time). The recipient can also select to receive a text version of the announcement (e.g., if text is more convenient for the recipient; if the streaming of the stored audio is unclear to the recipient).

In another example, a recipient with a hearing prosthesis (e.g., device 310) with an external sound processor (e.g., external device 320) and a mobile device (e.g., smart phone; smart watch; another external device 320) in communication with the sound processor in accordance with certain implementations described herein can enter a mass transit train station where a location-based Bluetooth wireless broadcast (e.g., broadcast stream 412) is being used to mirror the normal announcements made over the speaker system. The station can be one that the recipient is at every workday morning to ride the same commuter train, and the mobile device can present a notification pop-up text message offering to connect to the station's wireless broadcast (e.g., to receive the wireless broadcast via the data input interface 450) and to enable the functionality of certain implementations described herein. Upon the recipient selection to do so, the mobile device can access keywords relevant to the recipient's normal commuter train (e.g., name; time; track; platform). These keywords can be received from input from the recipient, automatically from information obtained from a calendar application on the mobile device, and/or automatically from previously-stored keywords corresponding to previous commutes by the recipient. If there is an announcement of a platform change for the recipient's commuter train, the announcement can be presented to the recipient via a warning buzz by the mobile device followed by a text message informing the recipient of the platform change. The recipient can then go to the new platform without interruption of the music that the recipient had been listening to.

In another example, a recipient with a hearing prosthesis (e.g., device 310) with an external sound processor (e.g., external device 320) and a mobile device (e.g., smart phone; smart watch; another external device 320) in communication with the sound processor in accordance with certain implementations described herein can attend an event with their family where a location-based Bluetooth wireless broadcast (e.g., broadcast stream 412) is being used to mirror the normal announcements made over the speaker system. The announcements can be about the location of certain keynote talks, and the recipient can scroll through a list of these announcements, with the most recent announcements appearing at the top of the list in real-time. The recipient can configure the mobile device to not play audible notifications for this category of announcements, but to play audible notifications for one or more second categories of announcements having higher importance to the recipient (e.g., announcements including one or more keywords having higher priority or importance over others). If an announcement is broadcast referring to the recipient's automobile by its license plate number (e.g., an automobile with the license plate number is about to be towed), because the recipient had previously entered the license plate number in a list of high-priority keywords, the announcement can trigger an audible notification for the recipient so the recipient can immediately check it and respond.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of various devices, various implementations described herein can be incorporated in a variety of other suitable devices, methods, and contexts. More generally, as can be appreciated, certain implementations described herein can be used in a variety of implantable medical device contexts that can benefit from certain attributes described herein.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein but should be defined only in accordance with the claims and their equivalents.

1. An apparatus comprising:
voice activity detection (VAD) circuitry configured to analyze one or more broadcast streams comprising audio data, to identify first segments of the one or more broadcast streams in which the audio data includes speech data, and to identify second segments of the one or more broadcast streams in which the audio data does not include speech data;
derivation circuitry configured to receive the first segments and, for each first segment, to derive one or more words from the speech data of the first segment;
keyword detection circuitry configured to, for each first segment, receive the one or more words and to generate keyword information indicative of whether at least one word of the one or more words is among a set of stored keywords; and
decision circuitry configured to receive the first segments, the one or more words of each of the first segments, and the keyword information for each of the first segments and, for each first segment, to select, based at least in part on the keyword information, among a plurality of options regarding communication of information indicative of the first segment to a recipient.

2. The apparatus of claim 1, wherein the VAD circuitry, the derivation circuitry, the keyword detection circuitry, and the decision circuitry are components of one or more microprocessors.

3. The apparatus of claim 2, further comprising an external device configured to be worn, held, and/or carried by the recipient, the external device comprising at least one microprocessor of the one or more microprocessors.

4. The apparatus of claim 2, further comprising a sensory prosthesis configured to be worn by the recipient or implanted on and/or within the recipient's body, the sensory prosthesis comprising at least one microprocessor of the one or more microprocessors.

5. The apparatus of claim 4, wherein the sensory prosthesis and the external device are in wireless communication with one another.

6. The apparatus of claim 1, wherein the VAD circuitry is further configured to parse the first segments from the second segments, to exclude the second segments from further processing, and to transmit the first segments to the derivation circuitry and the decision circuitry.

7. The apparatus of claim 1, wherein the derivation circuitry is further configured to transmit the one or more words to the keyword detection circuitry.

8. The apparatus of claim 1, wherein the keyword detection circuitry is further configured to retrieve the set of stored keywords from memory circuitry.

9. The apparatus of claim 1, wherein the set of stored keywords comprises, for each stored keyword, information indicative of an importance of the stored keyword.

10. The apparatus of claim 1, further comprising keyword generation circuitry configured to generate at least some keywords of the set of stored keywords.

11. The apparatus of claim 10, wherein the keyword generation circuitry is configured to receive input information from at least one keyword source and/or at least one importance source.

12. The apparatus of claim 11, wherein the input information from at least one keyword source and/or the at least one importance source comprise information provided by the recipient.

13. The apparatus of claim 1, wherein the plurality of options regarding communication of information indicative of the first segment to the recipient comprises at least one of:
at least one text message indicative of the one or more words of the first segment;
at least one visual, audio, and/or tactile signal indicative of whether the one or more words of the first segment comprises a stored keyword, indicative of an identification of the stored keyword, and/or indicative of an importance of the stored keyword;
at least one signal indicative of the audio data of the first segment and communicated to the recipient; and
at least one signal indicative of the audio data of the first segment and transmitted to memory circuitry to be stored and subsequently retrieved and communicated to the recipient.

14. A method comprising:
receiving one or more electromagnetic wireless broadcast streams comprising audio data;
dividing the one or more electromagnetic wireless broadcast streams into a plurality of segments comprising speech-including segments and speech-excluding segments;
evaluating the audio data of each speech-including segment for inclusion of at least one keyword; and
based on said evaluating, communicating information regarding the speech-including segment to a user.

15. The method of claim 14, wherein said receiving is performed by a personal electronic device worn, held, and/or carried by the user or implanted on or within the user's body.

16. The method of claim 14, wherein the one or more electromagnetic wireless broadcast streams comprises at least one Bluetooth broadcast stream.

17. The method of claim 14, wherein said dividing comprises:
detecting at least one characteristic for each segment of the plurality of segments;
determining, for each segment of the plurality of segments, whether the at least one characteristic is indicative of either the segment being a speech-including segment or a speech-excluding segment; and
appending information to at least some of the segments, the information indicative of whether the segment is a speech-including segment or a speech-excluding segment.

18. The method of claim 17, wherein said dividing further comprises excluding the speech-excluding segments from further processing.

19. The method of claim 14, wherein said evaluating comprises:
extracting one or more words from the audio data of the speech-including segment;
comparing the one or more words to a set of keywords to detect the at least one keyword within the one or more words; and
appending information to at least some of the speech-including segments, the information indicative of existence and/or identity of the detected at least one keyword within the one or more words of the speech-including segment.

20. The method of claim 19, wherein the set of keywords is compiled from at least one of: user input, time of day, user's geographic location when the speech-including segment is received, history of previous user input, and/or information from computer memory or one or more computing applications.

21. The method of claim 14, wherein said evaluating further comprises assigning an importance level to the speech-including segment.

22. The method of claim 21, wherein the importance level is based at least in part on existence and/or identity of the at least one keyword, user input, time of day, user's geographic location when the speech-including segment is received, history of previous user input, and/or information from computer memory or one or more computing applications.

23. The method of claim 14, wherein said communicating information is selected from the group consisting of:
displaying at least one text message to the user, the at least one text message indicative of the one or more words of the speech-including segment;
providing at least one visual, audio, and/or tactile signal to the user, the at least one visual, audio, and/or tactile signal indicative of whether the speech-including segment comprises a keyword, an identification of the keyword, and/or an importance of the keyword;
providing at least one signal indicative of the audio data of the speech-including segment to the user; and
storing at least one signal indicative of the audio data of the speech-including segment in memory circuitry, and subsequently retrieving the stored at least one signal from the memory circuitry and providing the stored at least one signal to the user.

24. A non-transitory computer readable storage medium having stored thereon a computer program that instructs a computer system to segment real-time audio information into distinct sections of information by at least:
receiving one or more electromagnetic wireless broadcast streams comprising audio information;
segmenting the one or more electromagnetic wireless broadcast streams into a plurality of sections comprising speech-including sections and speech-excluding sections;
evaluating the audio information of each speech-including section for inclusion of at least one keyword; and
based on said evaluating, communicating information regarding the speech-including section to a user.

25. The non-transitory computer readable storage medium of claim 24, wherein segmenting the one or more electromagnetic wireless broadcast streams comprises:
detecting at least one characteristic for each section of the plurality of sections;
determining, for each section of the plurality of sections, whether the at least one characteristic is indicative of either the section being a speech-including section or a speech-excluding section;
appending information to at least some of the sections, the information indicative of whether the section is a speech-including section or a speech-excluding section; and
excluding the speech-excluding sections from further processing.

26. The non-transitory computer readable storage medium of claim 24, wherein evaluating the audio information comprises:
extracting one or more words from the audio information of each speech-including section;
comparing the one or more words to a set of keywords to detect the at least one keyword within the one or more words;
appending information to at least some of the speech-including sections, the information indicative of existence and/or identity of the detected at least one keyword within the one or more words of the speech-including section;
assigning an importance level to the speech-including section, the importance level based at least in part on existence and/or identity of the at least one keyword, user input, time of day, user's geographic location when the speech-including section is received, history of previous user input, and/or information from computer memory or one or more computing applications.

27. The non-transitory computer readable storage medium of claim 24, further comprising compiling the set of keywords from at least one of: user input, time of day, user's geographic location when the speech-including section is received, history of previous user input, and/or information from computer memory or one or more computing applications.

28. The non-transitory computer readable storage medium of claim 24, further comprising, based on whether the one or more words includes at least one keyword, the identity of the included at least one keyword, and/or the importance level of the speech-including section, selecting whether to communicate the information regarding the speech-including section to the user or to not communicate the information regarding the speech-including section to the user.

29. The non-transitory computer readable storage medium of claim 28, wherein communicating the information comprises at least one of:
displaying at least one text message to the user, the at least one text message indicative of the one or more words of the speech-including section;
providing at least one visual, audio, and/or tactile signal to the user, the at least one visual, audio, and/or tactile signal indicative of whether the speech-including section comprises a keyword, an identification of the keyword, and/or an importance of the keyword;
providing at least one signal indicative of the audio information of the speech-including section to the user; and
storing at least one signal indicative of the audio information of the speech-including section in memory circuitry, and subsequently retrieving the stored at least one signal from the memory circuitry and providing the stored at least one signal to the user.
